(19) United States
(12) Patent Application Publication
(10) Pub. No.: US 2003/0137702 A1
(43) Pub. Date: Jul. 24, 2003

(54) Light distribution system for scanning radiographic images

(76) Inventor: Richard Gerlach, Rolling Hills Estates, CA (US)

Correspondence Address: ROBERT J. SCHAAP, Suite 188, 21241Ventura Boulevard, Woodland Hills, CA, 91364, US

(21) Appl. No.: 10/342,090

(22) Filed: Jan. 13, 2003

Related U.S. Application Data
(60) Provisional application No. 60/351,209, filed on Jan. 22, 2002.

(51) Int. Cl. H04N 1/04

(52) U.S. Cl. 358/484

(57) ABSTRACT

A light distribution system which enables the scanning of radiographic images to provide an electrical signal representation of the radiographic image which can be processed, stored and retrieved and transmitted for viewing at a remote site. In particular, the light distribution system relies upon a laser light source which distributes light to a rotating single optical fiber and which then successively distributes light to individual optical fibers which are located initially in a circular array. The light carried by these individual optical fibers is delivered to a linearizing member where the light is then arranged in a linear array so that each of the optical fibers delivers the light in this linear array. A detector located on an opposite side of a substrate with respect to the linear array of light can then be scanned on a line by line basis and with the light information generated thereby digitized and stored.

### BACKGROUND OF THE INVENTION

1. Field of the Invention

This invention relates in general to certain new and useful improvements in a light distribution system for delivering light, such as laser light, to a light receiving member and where the light from that light receiving member can pass light through a substrate on a line by line basis, thereby creating light signals representative of the image on the substrate. More particularly, the fiber optic cables are initially located in a circular array and deliver light to a linearizing member where the light can be used for scanning on a line by line basis.

2. Brief Description of Related Art

In recent years, storage, retrieval and transmission of radiographic images has received widespread acceptance. Generally, images are obtained at a location, such as a site of a physician's office or a hospital. Images of this type may be taken for bone structure or used in an orthopedic treatment, a brain scan to determine if a tumor were present, and in a wide variety of other medical situations. Also frequently, these various different types of radiographic images require parties with differing skills to review and interpret the results of that radiographic image. Very frequently, the hospital or physician who generates the radiographic image may not have the necessary expertise, training or experience to properly evaluate that radiographic image, and hence, there is a need to obtain the services of a party who can interpret the image, and who may also be located at a remote site.

Very frequently, and as examples of the foregoing, hospitals and physicians located in small towns do not have the immediate availability of the services of a physician who has the capabilities of a radiologist, or other party having the capabilities of examining a particular type of radiographic image. They may, therefore, need to send that image to someone having such capabilities at a remote site. The use of a delivery service frequently involves days, and in some cases, interpretation of the image and treatment based thereon may be imminent.

In many cases, patients have had an image taken in one location and now find need to visit a physician in another location, and where the physician in that other location may have need to examine previous radiographic images to determine a history of a certain condition. In addition, with cruise ships and, for that matter, even military hospital ships, the physicians on those ships may not have the necessary capabilities of reviewing such radiographic images which are generated, and need to obtain input with respect to such radiographic images. Moreover, and in some cases, the input sought by a particular physician may be needed on an emergency basis, as aforesaid.

In many cases, the manufacturers of scanning devices which are used for the scanning of a radiographic image have relied upon that technology used in photocopiers. Unfortunately, the technology used in photocopiers does not easily translate into an efficient system for scanning of radiographic images. Numerous problems which arise with the use of photocopier technology is due to the simple, yet critical, fact that photocopier technology is based on the use of a substrate which is typically opaque, and usually the image on only one side thereof is scanned, whereas in radiographic images, the substrate is generally transparent.

One of the problems with many of the conventional lighting systems which were employed, is the fact that the light source itself inevitably contained both hot spots and cold spots. In other words, light in certain areas may be excessive compared to areas in which the light is of a lesser intensity. In these cases, if the amount of light given by a light source were traced across the length of that light source in a line scan, one could graphically represent that light with a meandering curve to show the various areas of excessive light and insufficient light.

The lack of uniformity in a light source clearly interferes with the quality of the scanning of the image. Although this is not a problem in photocopiers, it is a significant problem when scanning a radiographic image, and particularly, where small detail is required. Nevertheless, the lack of linearity of an output across the length of a light source is a significant disadvantage in an attempt to obtain a precise reproduction of an image on a film or other substrate.

In these prior art light sources for scanning of documents, there were attempts made to account for these non-linearities by empirical attempts at calibration of the non-linearities in the light source. However, the attempts to calibrate in response to non-linear light sources were inefficient, at best, and resulted in discontinuities in the images as the image changed from very light to very dark. In some cases, there were attempts to originally scan the document in order to measure the non-linearities of the light source followed by a second scanning movement in which data was read along with an attempt to account for the non-linearities. Again, this system was not terribly effective.

In the prior art, attempts were also made to compensate for the light and dark areas from a light source by integrating the light source in a transverse direction to the movement of the document. Thus, if a dark spot on the light source occurred, an integration of the light was made transversely to the direction of movement of the document in an attempt to compensate for and integrate these light and dark areas. However, and here again, integration did not account for the fact that the light from a dark spot on the light source was also mixed with light from adjacent areas. This partially canceled out the effect of the dark spot. However, there was no total cancellation of the dark spot and, for that matter, no filling in for the excessively light areas. As a result, there was an over integration of light to account for a dark spot and this resulted in light streaks on the image when reproduced.

In more recent years, the use of laser light for scanning has also been adopted. Typically, the systems which rely upon laser light, such as from a gas laser, also require the need for a complex system of lenses and mirrors, along with a galvanometer. Systems of this type require a large number of moving parts, and hence, are not as reliable as they could desirably be. Secondly, they entail high manufacturing costs. The fact that lenses and mirrors are employed almost always necessitates frequent adjustment, along with the down time which requires periodic maintenance. The complex optical system alone, which includes multiple lenses and mirrors, frequently require cleaning of the lenses and mirrors. This, again, necessitates service and hence, down time in the use of such a scanning system. Moreover, systems of this type are costly, since they include high cost photomultiplier detectors and galvanometers to control raster scanning of the laser beam.

Systems of the type which use this laser technology are therefore, expensive and entail high manufacturing costs, as aforesaid. The gas laser alone degrades over time, requiring periodic calibration and eventual replacement, roughly from 2,000 to 5,000 hours of use. Moreover, this replacement must be conducted by a qualified manufacturer-trained technician.

The complex array of precision lenses and mirrors also contribute to veiling glare, as a result of edge reflections and surface contaminations (dust and haze). This requires frequent cleaning and adjustment, as aforesaid. Where frequent cleaning and adjustment is not provided, pixel measurements are compromised. The galvanometer requires delicate adjustments, as aforesaid, and the photomultiplier which also degrades over time, requires system re-calibration and eventual replacement after a period of time.

The issue of veiling glare actually results from scattered light being introduced into the pixel sensors from the optical system, and by components which are actually outside of the direct path of the pixel being sampled. This includes, for example, reflection off of lens surfaces and dust, scattered light from optical components, and the like, as aforesaid.

There has been a need for an optical system of this type which will allow for accurate scanning of a radiographic image without the problems of hot and cold spots, and without the significant problem of veiling glare, and which relies upon fiber optic technology delivery systems.

### OBJECTS OF THE INVENTION

It is, therefore, one of the primary objects of the present invention to provide a light distribution system which is highly effective in scanning an image on a generally transparent substrate, using an optical fiber network which allows for delivery of light from a light source successively to a plurality of fiber optic light guides.

It is another object of the present invention to provide an apparatus enabling the scanning of an image on a generally transparent substrate, in which light is arranged from a circular array of optical fibers into a linear array for scanning on a line by line basis.

It is a further object of the present invention to provide an apparatus for generating an electrical representation of an image on a generally transparent substrate, using successive lighting and distribution of light to a plurality of fiber optic cables and for detecting the output of light from those cables on an opposite side of the substrate to provide for electrical signals representative of the image.

It is an additional object of the present invention to provide a fiber optic scan-line interface to a laser distributor, which is highly accurate and efficient, stable, durable, and reliable.

It is still a further object of the present invention to provide a light distribution system to a plurality of light carrying conduits, and which provides for perfect rotation, on both an X and Y axis, high stability and constant velocity.

It is also an object of the present invention to provide a light distribution system, of the type stated, using a high density tracking of light to provide for high resolution sampling.

It is yet another object of the present invention to provide a laser light distribution system to a radiographic film of the type stated, which provides for interlocked film speed and pixel sampling, and yet allowing for plus or minus one pixel geometry over an entire scanned film.

It is still another object of the present invention to provide an apparatus for generating an electrical representation of an image on a generally transparent substrate, which is solid state in operation, rugged and linear, over at least seven decades and with a constant response not provided by other prior art systems.

It is yet another salient object of the present invention to provide a method of generating an electrical representation of an image on a generally transparent substrate by defining the image with successively provided laser light signals, to provide an electrical signal representation of that image.

With the above and other objects in view, my invention resides in the novel features of form, construction, arrangement and combination of parts and components presently described and pointed out in the claims.

### BRIEF SUMMARY OF THE INVENTION

The present invention resides, in a broad sense, in an apparatus and a method for scanning a generally transparent substrate containing an image thereon, and particularly, a film with a radiographic image thereon. Thus, for example, the film may be that from an x-ray, magnetic resonance imaging system, or computer topography system. The scanning will thereupon enable the generation of an electrical signal, such as an analog electrical signal, which is converted into an equivalent digital signal for storage and ultimate retrieval, and for long distance transmission.

In accordance with the resent invention, the term “radiographic image” is that image which may be taken by any of a variety of types of equipment, such as, for example, an x-ray, a magnetic resonance imaging system, or a topographic imaging system. Moreover, the image is preferably that of a medical image.

The invention herein primarily lies in the scanning system and the means for generating the light signals which can ultimately be converted into electrical signals for storage and retrieval and transmission. More particularly, the invention lies in the distribution of laser light at a plurality of optical fibers. The light from a light source, as for example, a laser light source, is introduced on a sequential basis, into a large number of these individual fiber optic filaments or optical fibers. These filaments are present in a number sufficient to achieve a sampling of each element in a scan line of a document which is scanned. Thus, and for an average radiographic film, 3,600 fiber optic filaments are arranged for successively, but nevertheless, quickly and efficiently, receiving light from the light source.

The number of optical fibers or filaments which are used may vary, depending upon the degree of resolution which is sought. Moreover, the light is generated so that scanning of a document may take place on a line by line basis successively, such that each line is sequentially examined. If there were 3,000 pixels in a line, then there would be approximately 3,000 fiber optic filaments, or more.

In each document to be scanned and digitized, such as a radiographic film, a plurality of successive scan lines extending across the document in one dimension, such as the width of the document, are established. Each scan line extends essentially transversely across this dimension, e.g., the width of the document, as aforesaid, and there are a plurality of scan lines successively arranged over the other dimension such as, for example, the length of the document. In each scan line there will be a plurality of scan operations, that is, where an individual scan or sampling is made. Consequently, a plurality of successive scan operations will take place transversely across the width of the document, such that there may be several hundred or over several thousand successive scan operations which take place in each scan line. Each scan operation essentially results in the detection of a pixel of light and the number of pixels of light is also independent of the number of optical fibers.

In actual construction of the light distribution system, light is obtained from a light source, and preferably, a laser light source, such as a gas laser light. This light is sequentially introduced into each of the aforesaid fiber optic filaments. A single fiber optic lead delivery filament or optical fiber, sometimes hereinafter referred to as a “light feed fiber”, has one end located at a disc in proximity to the laser light source, and another end which carries light from this laser light source to first ends of each of the individual fiber optic filaments. This lead filament cable, which comprises a single fiber optic filament, extends through the disc and terminates on the periphery thereof.

Each of the fiber optical fibers are also located, preferably in a generally circular array. As the disc rotates, the light carried by the light lead fiber is delivered successively into each subsequent fiber optical filament. When the disc has rotated a complete 360°, all filaments have been successively illuminated.

The filaments each have a second end, or output end, which is connected to a light bar. Preferably, this light bar is elongate and takes the filaments, which were previously arranged in a circular format at the first ends, and locates the second ends of these optical filaments linearly or in a line. Thus, each of the filaments are located with a distance apart from one another sufficient to provide a high resolution sampling of each single scan line of the document in a single pass. In other words, as the document is moved or as a reading means is moved, with respect to the length of the document, each successive scan line of the document is read. In like manner, the apparatus provides for reading of the contents of each scan line horizontally across the document on a pixel by pixel basis.

The invention can be generally described as an apparatus for generating an electrical representation of an image on a generally transparent substrate. In this case, the apparatus comprises a light source for generating a laser light. In addition, the apparatus includes a means for receiving the light and successively distributing this light to generally individual fiber optic light carrying members, such as, for example, optical fibers or filaments. This allows the light to travel along the light carrying members to opposite ends on each of these light carrying members. The apparatus also comprises a detecting means on an opposite side of the substrate to receive the light passing from the ends of each of these members through the substrate and creating light signals defining the image on that substrate. This allows the light signals to provide electrical signals representative of the image.

The means for receiving the laser light is preferably a rotating member which successively illuminates each one of the series of fiber optic light carrying members. More particularly, a single fiber optic cable receives the laser light at first ends thereof and delivers that light to the rotating member which successively distributes the light to individual fiber optic light carrying members. These optical fibers also have opposite second ends terminating at a linearizing member, to thereby distribute the light to a detecting means.

As indicated previously, the apparatus and the method are generally designed for the storage and retrieval of medical images, such as radiographic medical images. In this case, the generally transparent substrate containing the image is a radiographic film and the image is a medical image.

The invention can also be described as an apparatus for enabling the scanning of an image on a generally transparent substrate, including the light source for generating the laser light. This apparatus includes a plurality of optical fibers with each having a first end and a second end, and each optical fiber providing light to pass through the generally transparent substrate. In this way, the substrate can be scanned on a pixel by pixel basis. The first end of each of the ends of the fibers are located in an arrangement, such that they may successively receive light from the light source. A generally elongate distributing member receiving the second ends of each of the optical fibers locates this light carried by the optical fibers, where the substrate can be scanned on a line by line basis.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings (eight sheets) in which:

FIG. 1 is a schematic perspective view of a typical prior art laser scanning system;

FIG. 2 is a perspective view of one form of scanning and digitizing apparatus, in accordance with the present invention;

FIG. 3 is a somewhat schematic side elevational view with a side plate of the apparatus housing removed to show the interior of the scanning and digitizing apparatus of FIG. 2;

FIG. 4 is a front elevational view of a light distribution system, forming part of the apparatus of the present invention;

FIG. 5 is a perspective view of a light distribution system, and showing its relationship with respect to a detection and reading system, also forming part of the apparatus of the invention;

FIG. 6 is a side elevational view of the light distribution system and the relationship to the detection and reading system of the invention;

FIG. 7 is an enlarged fragmentary front elevational view showing details of the light distribution system of the invention;

FIG. 8 is an end elevational view of a light linearizing bar, forming part of the light distribution system of the present invention;

FIG. 9 is a view of the light linearizing bar of FIG. 8, taken substantially along the plane of line 9-9 of FIG. 8;

FIG. 10 is a schematic fragmentary plan view showing movement of a wave form on the interior of the light linearizing bar, with a mirror arrangement at the end thereof;

FIG. 11 is a diagrammatic view showing the amount of light achieved in a prior art scan, with a system using a photomultiplier and lenses and mirrors;

FIG. 12 is a diagrammatic view, similar to FIG. 11, and showing the amount of light achieved in any scan of the present invention; and

FIG. 13 is a composite view showing the relationship between optical fiber arrangement, representative light values and sampling time with the light distribution system of the present invention.

### DETAILED DESCRIPTION OF A PREFERRED EMBODIMENT

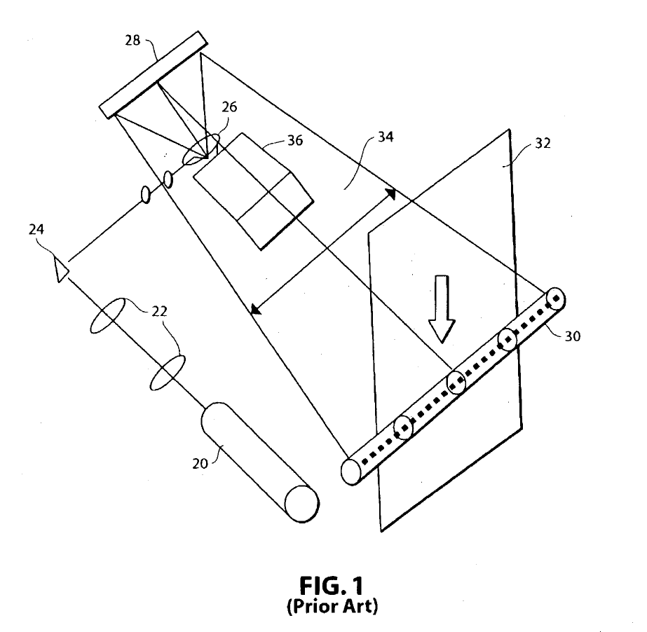

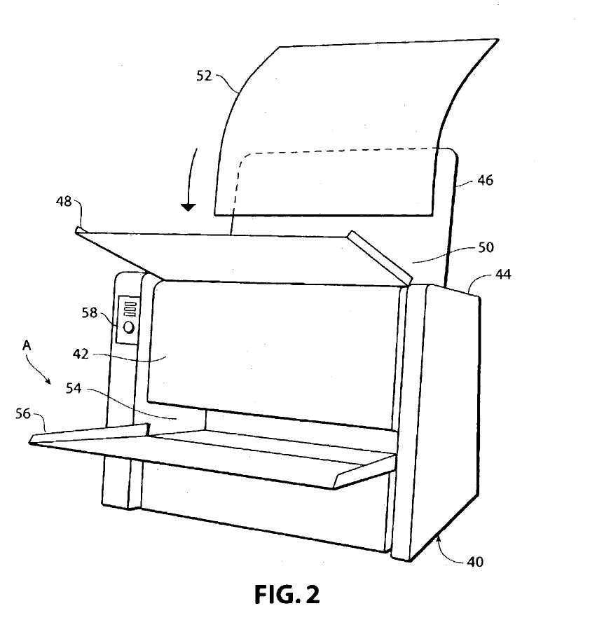

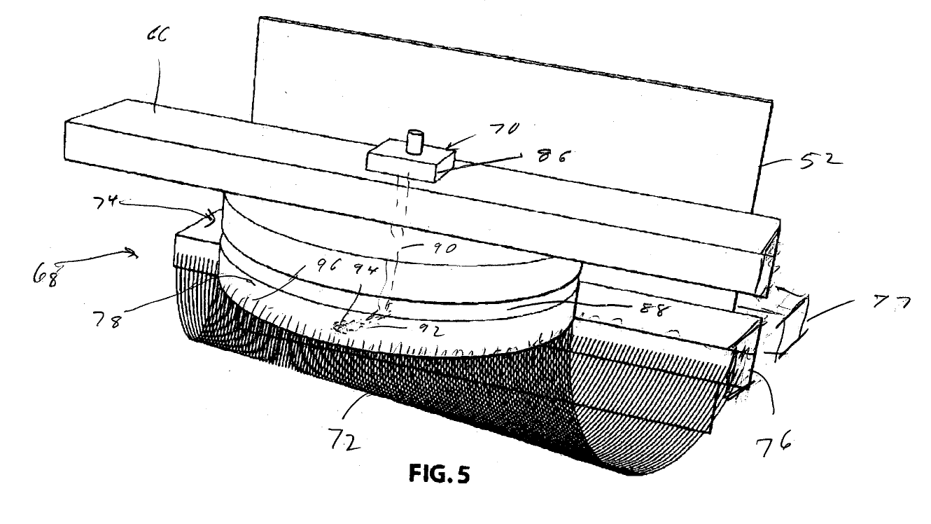

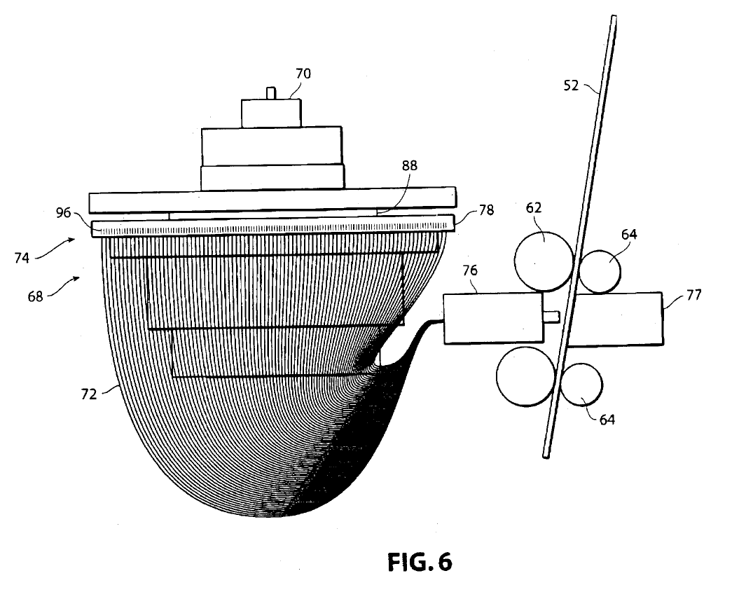

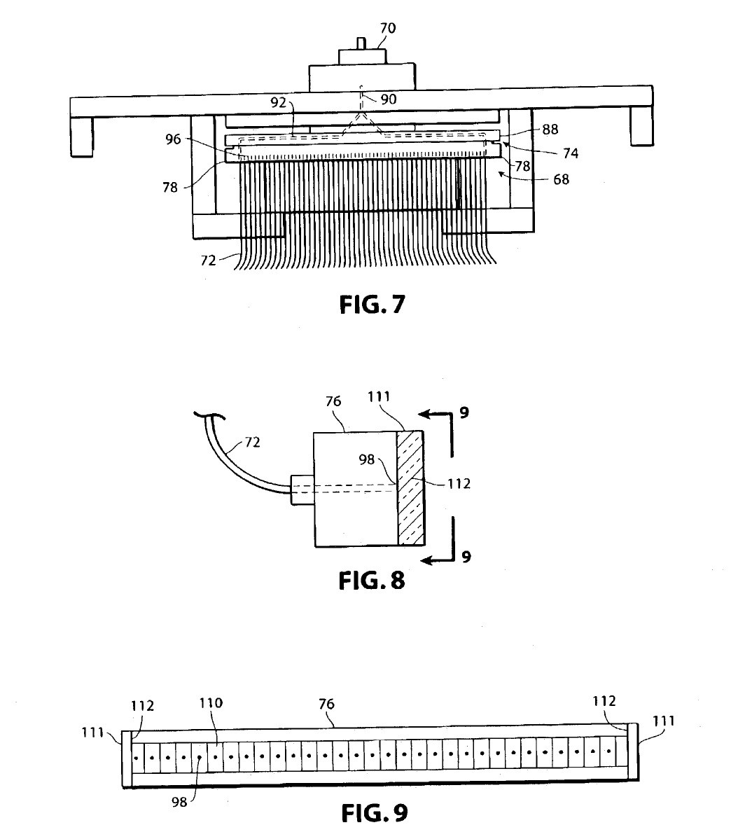

Referring now in more detail and by reference characters to the drawings, reference will initially be made to FIG. 1, which shows a typical prior art laser scanning system for scanning radiographic images. FIGS. 2-9 of the application more particularly relate to the apparatus and the method of the present invention.

Referring in more detail to FIG. 1, it can be observed that the prior art laser scanning systems generally rely upon a gas laser 20, including a plurality of condensing lenses 22, and a prism 24 directing light to a conical prism 26, and a folding mirror 28. That light from the mirror 28 is then directed to a photomultiplier detector 30. However, the light passes through the radiographic film substrate 32 and will thereupon provide a reading of the light and dark areas to the photomultiplier detector 30. The scanning beam generated at the folding mirror 28 is represented by the path 34. Moreover, a galvanometer 36 must be used in this arrangement to control raster scanning of the laser beam.

In substance, it can be observed that the prior art laser scanning systems, while being different from, nevertheless rely upon, technology similar to that used in conventional photocopiers. However, the prior art digitizing scanning systems, nevertheless, suffer from a large number of significant disadvantages, not the least of which is the high cost of expensive components coupled with high manufacturing costs.

Some of those expensive components, mentioned above, include the gas laser which is used since it degrades over time, requiring periodic calibration and eventual replacement. Usually, replacement is required every 2,000 to 5,000 hours, and usually by a qualified manufacturer-trained technician. The photomultiplier detector is also a costly item which similarly degrades over time, and also requires system re-calibration and eventual replacement. A galvanometer is costly and must be an accurate galvanometer to control raster scanning of the laser beam. This galvanometer also requires periodic calibration and very delicate adjustments. There is also a complex array of precision lenses and mirrors. Moreover, with these lenses and mirrors, every surface of same contribute to the veiling glare, as a result of edge reflections and surface contamination. The surface contamination is impossible to eliminate, and is typically caused by dust in the air. However, these mirrors and lenses require periodic cleaning and adjustment by trained technicians, or otherwise, pixel measurements are compromised.

Those disadvantages mentioned above are only some of the major disadvantages. However, it is noteworthy that there is down time due to the need for periodic cleaning and adjustment. In addition, a premature burn-out of, for example, the gas laser or photomultiplier could require early replacement. Although some manufacturers may provide a warranty policy, even that policy is expensive and adds to the overall cost of the system.

As indicated above, FIGS. 2-13 of the drawings more particularly illustrate both the apparatus and the method of the present invention. Returning now to FIGS. 2-13, A represents a radiographic image storage and retrieval apparatus, which includes an outer housing 40 having a front wall 42 and a top wall 44. A pair of plates 46 and 48 define a space for a feed slot 50 to receive a radiographic film substrate 52. The front wall 42 is also provided with an elongate exit slot 54 and a film receiving tray 56, to receive the film 52 after the same has been read and is discharged through the slot 54.

The apparatus is also provided on the outer housing 40 with a control panel 58, containing those controls necessary for the operation of the apparatus. These controls typically include an off-on switch, a speed control, and the like.

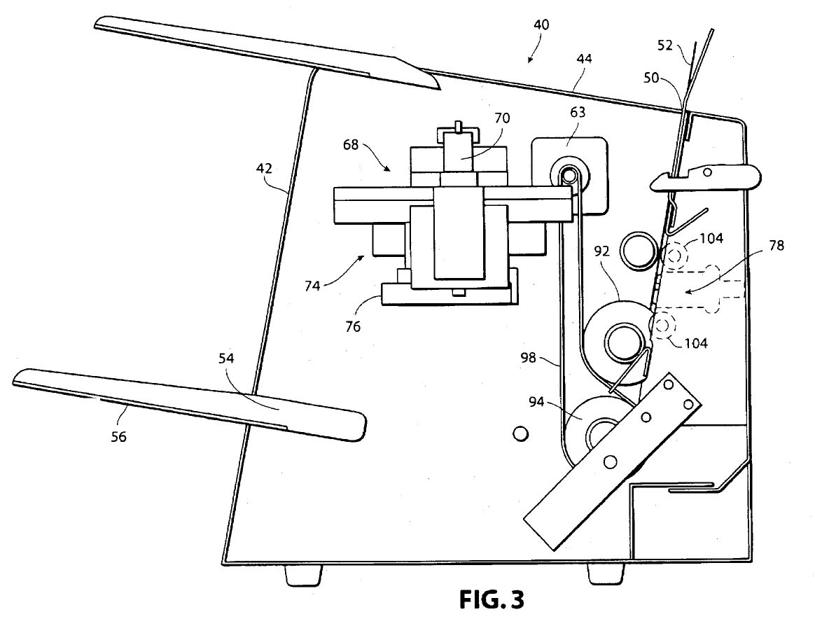

Referring now to FIG. 3, there is provided a drive system 60 for receiving the radiographic film, and moving same through the housing 40 of the apparatus. This drive system generally includes a drive roller 62 connected to an electrical motor 63, along with idler rollers 64. The actual drive mechanism is more fully described in my co-pending U.S. patent application Ser. No. 09/594,074, filed Jun. 12, 2002, entitled “Drive System for Digitizing Scanning Apparatus.” Although this particular drive system is not critical for use in the present invention, it certainly has been found to be beneficial, in that it represents an improvement over other prior art drive systems.

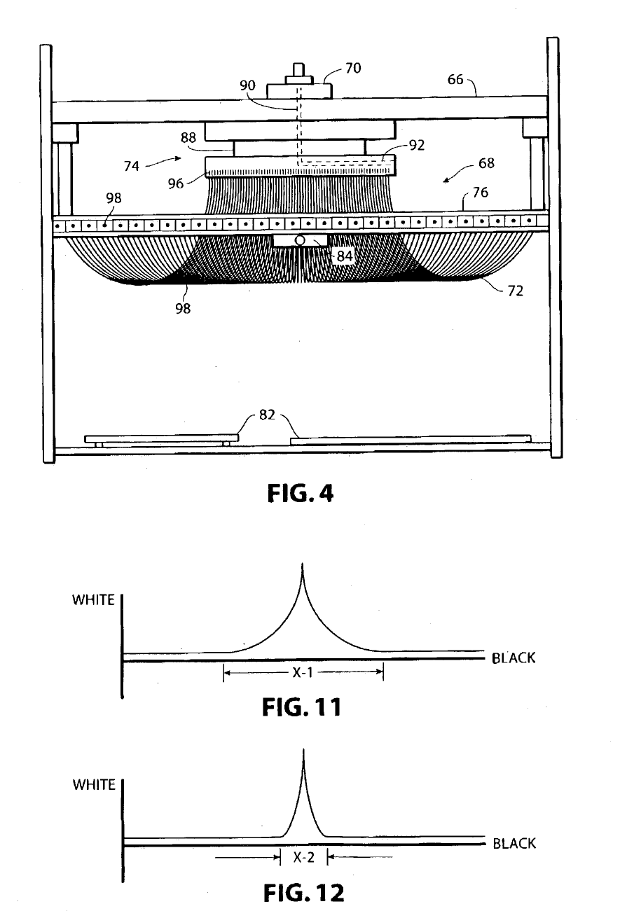

A horizontal support plate 66 mounted within the apparatus, as shown in FIG. 4, supports the laser light distribution system 68, which is one of the key components forming part of the apparatus of the present invention. This laser light distribution system includes a laser light source 70, a plurality of fiber optic cables 72, and a laser light feed mechanism 74. The laser light distribution system also includes a light linearizing distribution bar 76.

In brief summary, optical fibers are connected to a stationary plate 78, forming part of the light feed mechanism 74, and receives light from a light feed filament, hereinafter described, for distribution to each of the individual optical fibers 72. The light feed filament rotates around the ends of each of the individual fibers 72. These fibers 72 have first ends mounted on the plate 78 and second ends located at the rear side of the light distribution and linearizing bar 76. In this way, light from a rotating distribution feed is introduced into a linearizing distribution member for ultimate use. In particular, the light is passed through the film substrate 52 and detected by a detector 77. As the film substrate 52 is moved past the light distribution bar 76 and the light detector 77, the light passing through the substrate 52 is detected and read for ultimate conversion to electrical signals for storage and retrieval.

This light detection and reading system is not the subject matter of the present invention, but is briefly described herein to show its relationship to and operation with the light distribution system of the invention. This detection and reading system is more fully described and illustrated in my U.S. patent application Ser. No. ______, filed Jan. 13, 2003, and entitled “Light Reading and Detection System for Scanning a Radiographic Image,” and which is based on my U.S. Provisional Patent Application Serial No. 60/351,210, filed Jan. 14, 2002.

Also mounted within the housing of the apparatus are one or more electronic circuit boards 82, which control the actual operation of the apparatus. In addition, the apparatus could include its own internal power supply (not shown). Inasmuch as the actual electronics is only that necessary for operating the drive system and, essentially, the optical system herein, it is neither illustrated nor described in any further detail herein. However, it is important to note that an encoder 84 also forms part of the apparatus, so that the light levels may be read on an encoded time basis.

FIGS. 5-13 more specifically illustrate certain details of the light distribution mechanism 74, forming part of the apparatus of the present invention. This light distribution mechanism includes the aforesaid laser light source 70, which is mounted on and forms part of a circuit board 86, with the latter supported by the horizontal support plate 66. The light feed mechanism 74 is mounted on the underside of the support plate 66. The light feed mechanism includes a rotating plate 88 associated with, or disposed within, a recess in the plate 78. The rotating plate 88 is rotated by a suitable electric motor (not shown), and in effect, receives a light feed filament 90 from the laser light source 70. The light feed filament 90 has a section 92 which is turned laterally toward the circumference of the rotating plate 88, and has an end which terminates so that this end of the light feed is successively aligned with each of the ends of the optical fibers 72, at the peripheral edge of the plate 78. Thus the section 72 of the light feed terminates at the periphery of the plate 88.

The plate 78, which has a recess sized to receive the plate 88, also receives the first ends 96 of each of a plurality of individual optical fibers 72, and which first ends 96 terminate at the plate 78, all as best shown in FIGS. 4, 5 and 6 of the drawings. These first ends 96 are located in a circular array around the cylindrically shaped plate 78, and receive light successively from the rotating feed filament 90, and particularly, at the outer end 94 thereof.. Thus, as this outer end 94 passes the first ends 96 of each of the individual optical fibers 72, it will transfer light from the laser light source 70 into each of the individual fibers 72.

Each of these individual filaments or fibers have second ends 98 which are secured to and deliver light to the linearizing bar 76, in a manner to be hereinafter described in more detail. In other words, it can be observed that as the plate 88 rotates, light will be successively distributed to each of the optical filaments or fibers 72, since the latter have ends located about a circumference, essentially matching that of the disc 88.

In the preferred embodiment of the invention, there are no less than 3,600 optical fibers. Thus, and with the use of 3,600 optical fibers, it is possible to conduct at least 3,600 or more samplings or so-called “scan operations”, in each line of the document being examined. Thus, there can be 3,600 pixels or more of light for each scan line of the document, such as the film 52.

The encoder 84 is mounted on the underside of the light bar 76, and thereby provides a clock pulse or timing pulse each time that a scan is made. In this way, the level of light at each point along the scan line with respect to the document is determined in time, so that the scan line, and hence, each scan line of the document, can be recreated. In other words, by knowing the light level at any point in time during a complete scanning operation, it is possible to regenerate the image on the film being scanned.

The linearizing light bar 76 is also more fully illustrated in FIGS. 4, 8 and 9 of the drawings. In this case, it can be observed that the second ends 98 of each of the optical fibers 72, are located at the edge of the light linearizing bar 76. Each of the optical fibers which carry the laser light will, therefore, permit a distribution of that light at the edge of the linearizing bar 76. In addition, the linearizing bar 76 may be provided with individual compartments 110 with each receiving an end 98 of each separate optical fiber 72, and which extends to the forward edge of the linearizing bar 76. At each of the opposite ends of the linearizing bar 76, there are forwardly struck end plates 111. These edges have interior polished surfaces 112, which serve as mirrored surfaces, all as best shown in FIGS. 8 and 9. In this way, the mirrored surfaces 112 will reflect any light back into the interior of the linearizing bar, such that no light is lost.

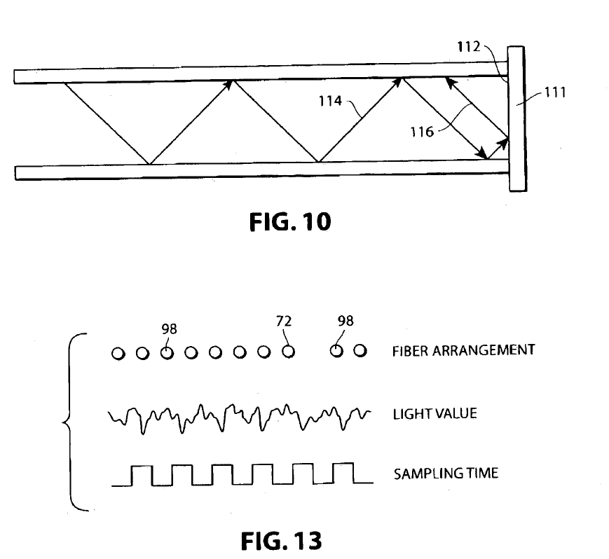

By reference to FIG. 10, it can be observed that light entering into the linearizing bar 76, may be reflected between two surfaces thereof, as shown by the wave path 114. At the end, and as a result of the mirrored surfaces 112, it can be observed that any reflected light which might otherwise exit the system, is reflected back into the interior as shown by the wave pattern 116.

One of the unique aspects of the system of the present invention is that shown by FIGS. 11 and 12. In a typical mirror and lens approach using a laser light, the amount of light which is detected in every scan is that represented by distance X-1. In effect, the graph is set up to show light versus no light, and is identified as “white” for light and “black” for no light. However, when using the light scanning system of the present invention, it can be observed that the amount of extraneous light is substantially reduced, such that only the light X-2 is detected in each scan operation. Thus, the system of the invention is far more accurate than any of the prior art systems.

In effect, it can be seen that with the system using laser light and a photomultiplier with lenses and mirrors will result in a scanning of several hundred pixels at each scan. In contrast, with the present invention, the scan usually is no greater than five to ten pixels. Thus, there is no broad spectrum of light, but rather, only a focused light cone. In addition, and because of the small amount of pixels in each scan, there is no generation of a Moire pattern, and hence, there is no destructive-constructive interference of the light, which would otherwise destroying the banding.

It can be recognized that the arrangement of fibers at the output of the linearizing bar 76 may not be perfectly linear, and moreover, the ends 98 of the fibers 72 may not be uniformly spaced from one another, as shown by the representation identified as “fiber arrangement” in FIG. 13. The second representation in FIG. 13 shows the light values which are measured. It can be observed that where there is no optical fiber 98, there is a substantially reduced light value. Nevertheless, sampling may occur, as shown at the sampling time designation in FIG. 13. This indicates that the sampling will measure the amount of light at each sample. However, due to the fact that there may be an integration of light value the negative reading will be averaged out and will not negatively affect the reading in the detecting system. In addition, the mere fact that the optical fibers are not perfectly linearly aligned and uniformly spaced apart, similarly will not materially interfere with the reading.

The apparatus of the invention presents many advantages which are not available in any of the prior art systems. For example, the apparatus of the invention provides a perfect geometry of plus or minus one pixel in any scan. Moreover, this is effective even with fourteen inch by seventeen inch films. Secondly, the invention provides a sealed optical system. In effect, there is a clean entrance surface on the light guide, and a clean exit surface on the light guide. Thirdly, there is no periodic adjustment required. More importantly, the device is very inexpensive. In fact, it can be constructed so inexpensively, and with such almost failsafe components, that if there is a failure, it is possible to merely swap one device for another.

The apparatus of the invention is also highly toolable. This enables mass production. In addition, there is no optical bench, such as the lenses and mirrors which are used in all prior art systems. In prior art systems, the geometry continuously failed, whereas in the present system, the print is almost perfect on each occasion. Most importantly, there is no veiling glare. Thus, there is no sharp black to white contrast, due to the fact that several hundred pixels are not affected by any glare.

The system of the invention is highly accurate, stable, durable and reliable. It provides perfect rotation in an XY axis, along with high stability and constant velocity. It has a highly accurate, high density, clock track providing for high resolution sampling. In effect, the disc speed, film feed and pixel sampling are interlocked with plus or minus one pixel geometry over the entire film. Inasmuch as the output is always focused, there are no Newton interference patterns. The sealed optical path eliminates the need for cleaning and adjustment. Further, there is no cosine-4 power roll-off.

The film is moved with a clamshell design. As a result, there is perfect surface velocity and constant surface velocity. There is also a constant drive load independent of the film thickness.

The laser output sensor is solid state and very rugged. It is also linear over seven decades. The entire system thereby provides superior image quality, better reliability, fewer service calls, and a system which is highly manufacturable at a low cost.

Thus, there has been illustrated and described a unique and novel light distribution system for scanning radiographic images, and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by letters patent is:

1. Apparatus for generating an electrical representation of an image on a generally transparent substrate to enable a visual reproduction thereof, said apparatus comprising:
a) a light source for generating laser light;
b) means for receiving the light and successively distributing same to generally individual fiber optic light carrying members and allowing the light to travel along said light carrying members to ends on each of said members; and
c) detecting means on an opposite side of said substrate to receive the light passing from ends of said members through said substrate and creating light signals representative of the image on said substrate for allowing the light signals to provide electrical signals representative of the image.

2. The apparatus for generating an electrical representation of an image of claim 1 further characterized in that said apparatus comprises digitizing means for digitizing said electrical signals creating a digital representation of said image on said substrate.

3. The apparatus for generating an electrical representation of an image of claim 1 further characterized in that said light is a laser light.

4. The apparatus for generating an electrical representation of an image of claim 3 further characterized in that said light carrying members are each optical fibers.

5. The apparatus for generating an electrical representation of an image of claim 4 further characterized in that the means receiving the laser light is a rotating member which successively illuminates each one of a circular array of said optical fibers.

6. The apparatus for generating an electrical representation of an image of claim 4 further characterized in that the means receiving the laser light is a rotating cylindrically shaped disc which successively illuminates each one of the series of optical fiber light carrying members.

7. The apparatus for generating an electrical representation of an image of claim 5 further characterized in that a single feed optical fiber receives the laser light and delivers the light through the rotating member successively distributes the light to the individual fiber optic light carrying members.

8. The apparatus for generating an electrical reproduction of an image of claim 7 further characterized in that the optical fibers have first ends located at said rotating members and receives the light delivered thereto from the single feed optical fiber.

9. The apparatus for generating an electrical reproduction of an image of claim 7 further characterized in that said generally transparent substrate containing the image thereon is a radiographic film and said image is a medical image.

10. Apparatus for enabling the scanning of an image on a generally transparent substrate, said apparatus comprising:
a) a light source for generating a laser light;
b) a plurality of optical fibers with each having a first end and a second end and each optical fiber providing light to pass through the generally transparent substrate so that said substrate can be scanned on a pixel by pixel basis;
c) the first ends of each of the fibers being located in an arrangement so that they may successively receive light from the light source; and
d) a generally elongate light distributing member receiving the second ends of each of the optical fibers to locate the light carried by the optical fibers in a linear light array where the substrate can be scanned on a line by line basis.

11. The apparatus for enabling the scanning of an image of claim 10 further characterized in that the generally elongate light distributing member receives the second ends of the optical fibers in a generally linear array and linearizes the distribution of light from each of the optical fibers.

12. The apparatus for enabling the scanning of an image of claim 10 further characterized in that the apparatus comprises a detecting means on the opposite side of said substrate with respect to the generally elongate light distributing member to receive the light passing from the second ends of said optical fibers through the substrate and thereby defining the image on the substrate allowing the light passing therethrough to provide electrical signals representative of the image.

13. The apparatus for enabling the scanning of an image of claim 10 further characterized in that the first ends of the plurality of optical fibers are connected to a rotating member which successively illuminates each one of the optical fibers, and that said first ends of said optical fibers are located in a circular array around said member.

14. The apparatus for enabling the scanning of an image of claim 13 further characterized in that said rotating member is a cylindrically shaped disc with the first ends of the optical fibers located around the periphery of that disc.

15. The apparatus for enabling the scanning of an image of claim 10 further characterized in that a single feed optical fiber receives the laser light from a laser light source and delivers the laser light to the rotating member which rotates and successively distributes the light to the individual optical fiber which rotates.

16. The apparatus for enabling the scanning of an image of claim 10 further characterized in that said generally transparent substrate containing an image thereon is a radiographic film and said image is a medical image.

17. A method for generating an electrical representation of an image on a generally transparent substrate, said method comprising:
a) generating light from a light source;
b) introducing the generated light into a plurality of individual optical fibers on a successive basis and allowing the light to travel along the length of said fibers;
c) delivering the light to a linearizing member which locates the light from the optical fibers in a generally linear array thereby allowing for the scanning of the substrate on a line by line basis; and
d) converting the light passing through the substrate into electrical signals which can be stored and regenerated.

18. The method for generating an electrical representation of an image of claim 17 further characterized in that said method comprises:
delivering the light from the light source through a single optical light carrying feed fiber to first ends of the optical fibers when the first ends are located in a circular array as the feed fiber rotates and allowing the light to pass through second ends of each of the optical fibers.

19. The method for generating an electrical representation of an image of claim 17 further characterized in that the apparatus comprises a digitizing means for digitizing the electrical signal to thereby create a digital representation of the image on the substrate.

20. The method for generating an electrical representation of an image of claim 17 further characterized in that said substrate is a generally transparent substrate containing the image thereon which is a radiographic film and said image is a medical image.
